(19) United States
(12) Patent Application Publication
(10) Pub. No.: US 2018/0203996 A1
(43) Pub. Date: Jul. 19, 2018

(54) System And Method of Performing Memory Data Collection For Memory Forensics In A Computing Device

(71) Applicant: QUALCOMM Incorporated, San Diego, CA (US)

(72) Inventors: Sudha Anil Kumar Gathala, Tracy, CA (US); Mastooreh Salajegheh, Santa Clara, CA (US); Saumitra Mohan Das, San Jose, CA (US); Nayeem Islam, Palo Alto, CA (US)

(21) Appl. No.: 15/407,390

(22) Filed: Jan. 17, 2017

(51) Int. Cl. G06F 21/56; G06F 11/30

(52) U.S. Cl. CPC G06F 21/562; G06F 2201/84; G06F 11/3079; G06F 11/3037

(57) ABSTRACT

Various embodiments include systems, methods and devices for reducing the burden on mobile devices of memory data collection for memory forensics. Various embodiments may include monitoring for changes sections or portions of memory within the computing device that been identified by a network device based on a prior memory snapshot. When changes are detected, the computing device may determine whether data changes in the monitored sections or portions of memory satisfy a criterion for transmitting an incremental snapshot of memory. Such criteria may be defined in information received from the network device. When the criteria are satisfied, the computing device may transmit an incremental memory snapshot to the network device. The computing device may transmit to the network device results of analysis of the data changes observed in the memory. Various embodiments may be performed in a secure environment or in a memory collection processor within the computing device.

### BACKGROUND

Memory forensics is an analysis of a computer's volatile memory to determine information about executing programs, the operating system, uses of the computer, and/or the overall state of the computer. Digital forensic analysis of non-volatile storage as well as volatile memory is widely used by information technology (IT) departments and law-enforcement agencies. Memory forensics may be useful for detecting malicious software (i.e., malware) executing in the computer's memory.

Memory forensics typically involves collecting memory data from the computer's volatile and non-volatile memory at a specific time. The memory data that is collected is referred to herein as a “memory snapshot” and is sometimes referred to as a “memory dump.” Forensic analysis is particularly popular with laptop/desktop machines that have unlimited power and broadband network connections. However, downloading the contents of memory from mobile devices that run on battery power, such as smartphones, may consume enough energy to impact the usefulness of such devices. Yet mobile devices are a growing proportion of many networks and are the principle computing devices for many users.

### SUMMARY

Various embodiments include systems, methods, network devices, and computing devices to provide memory data downloads for memory forensics in a manner that reduces the frequency and amount of data downloaded. Various embodiments may include receiving in a computing device from a network device information identifying a section or portion of memory to be monitored for changes from a memory snapshot previously provided by the computing device to the network device, and monitoring the identified section or portion of memory for changes in data. Various embodiments may further include determining whether data changes in the monitored section or portion of memory satisfy a criterion for transmitting an incremental snapshot of memory if data within the monitored section or portion of memory has changed. The criterion for transmitting an incremental snapshot of memory may be defined in the information received from the network device. Various embodiments may further include transmitting an incremental snapshot of memory from the computing device to the network device in response to determining that data changes in the monitored section or portion of memory satisfy the criterion for transmitting the incremental snapshot of memory.

Some embodiments may further include generating the incremental snapshot of memory according to instructions received from the network device in the information received from a network device. In such embodiments, generating the incremental snapshot of memory may include performing an analysis on data that changed in the identified section or portion of memory according to the instructions received from the network device, and including results of the analysis within the incremental snapshot of memory. In such embodiments, generating the incremental snapshot of memory may include performing an analysis on data that changed in the identified the section or portion of memory according to the instructions received from the network device, in which the results of the analysis are the incremental snapshot of memory. In such embodiments, operations of monitoring identified sections of portion of memory, determining whether data changes in the monitored section or portion of memory satisfy the criterion for transmitting an incremental snapshot of memory, and generating the incremental snapshot of memory may be performed in a secure environment within the computing device or in a memory collection processor within the computing device. In some embodiments, determining whether data changes in the monitored section or portion of memory satisfy a criterion for transmitting an incremental snapshot of memory may include applying data collection rules received from the network device to changed data within the monitored section or portion of memory to determine whether changed data should be processed to generate an incremental snapshot of memory.

Further embodiments may include a computing device having memory coupled to a processor that is configured to perform operations of the methods summarized above. Further embodiments may include a computing device having means for performing functions of the methods summarized above. Further embodiments may include a non-transitory medium on which is stored processor-executable instructions configured to cause a processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a communication block diagram illustrating devices, networks, and systems suitable for implementing various embodiments.

FIG. 2A is a block diagram illustrating components of a computing device that may be configured to perform memory data collection according to some embodiments.

FIG. 2B is a schematic diagram illustrating processes and components of a computing device that may be configured to perform memory data collection according to some embodiments.

FIG. 3 is a process flow diagram illustrating a method of performing data collection according to some embodiments.

FIG. 4 is a process flow diagram illustrating a method of identifying portions of memory to be monitored and criteria and content of incremental snapshots of memory to be obtained according to some embodiments.

FIG. 5 is a schematic diagram illustrating components of a smartphone type mobile communication device suitable for use with various embodiments.

FIG. 6 is a schematic diagram illustrating components of a mobile communication device in the form of a laptop computer that is suitable for use with various embodiments.

FIG. 7 is a schematic diagram illustrating components of a server suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and hardware implementing such methods for efficiently performing memory collections (i.e., “snapshots”) on computing devices. In various embodiments, after an initial snapshot of the entire memory of a computing device has be uploaded to a network device (e.g., a server), a processor of the computing device may selectively monitor portions or sections of memory based on information received from the network device to detect changes or updates in data that are significant of have the potential to lead to non-benign behaviors. If such changes (e.g., interesting transactions or write operation) in monitored memory data are detected, the processor may obtain an incremental snapshot of the sensitive or relevant portions of the memory appropriate for forensic analysis and upload the incremental snapshot to the network device.

Various embodiments also include a network device (e.g., a server) configured to save and analyze the initial memory snapshot received from a computing device to determine/identify the portions or sections of memory that are most important or sensitive (e.g., include sensitive control data structures, process tables, socket addresses, etc.). The network device may format and send information to the computing device monitoring that identifies selected (e.g., the most important or sensitive) sections or portions of memory that should be monitored for changes by the computing device processor. The network device may also identify the types of information or selected portions of changed data that should be included in an incremental snapshot, enabling incremental snapshots to include less than all of the data that has changed since a preceding snapshot or incremental snapshot was received from the computing device. The network device may then update the stored snapshot of the computing device's memory with the incremental snapshot received from the computing device. The network device may perform additional analysis operations on the updated snapshot (or incremental snapshots) to identify additional or different portions of the memory that should be monitored by the mobile device, and send updated monitoring information to the computing device. The network device may also perform forensic analysis of the updated snapshot of the computing device's memory.

The term “computing device” is used herein to refer to an electronic device equipped with at least a processor. Examples of computing devices may include, but not limited to, personal computers (e.g., desktop computers and laptop computers), mobile communication devices (e.g., cellular telephones, wearable devices, smart-phones, web-pads, tablet computers, Internet enabled cellular telephones, Wi-Fi® enabled electronic devices, personal data assistants (PDA's), etc.), workstations, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

Malware may include any software that is used to disrupt computer operations, gather sensitive information, gain access to private computer systems, or display unwanted advertising. Malware may include, but is not limited to, computer viruses, worms, rootkits, Trojan horses, ransomware, spyware, adware, scareware, and other malicious software.

Memory forensics typically involves collecting the entire contents of memory in a “memory snapshot” or “memory dump.” Such memory data can then be analyzed to determine the state of the computer's volatile and non-volatile memory at a specific time. Types of memory data collected for memory forensics may include information on memory usage, such as map files, mem files, proc files, and other data about processes and other system information, for example.

Memory data collection may be performed offline or online Offline memory data collection occurs when a computer is no longer operating, such as after a program crash due to a computer attack. With offline memory data collection, there is a risk of losing memory content before it is collected, particularly if power is lost. Online memory data collection occurs while the computer in operation. With online memory data collection, there is less risk of memory content loss and thus is more reliable. Online memory data collection also enables real-time analysis of behaviors and operations of computing devices within a network. Further, some forensic analyses may be conducted in the background while computing devices are operating, thus requiring near real time memory images or snapshots to be available for analysis.

Downloading of memory images or snapshots is not generally a problem for computing devices coupled to a network via wired connections and powered by external power sources. However, downloading memory snapshots can cause operational problems for mobile computing devices that operate on battery power and communicate via wired communication links (e.g., such as cellular data networks). The time spent generating and transmitting a memory snapshot consumes power that drains the battery of mobile computing devices. Additionally, the bandwidth consumed by wirelessly transmitting memory images to a network device may be expensive and disrupt or slow down other forms of communications (e.g., voice or data calls).

Various embodiments enable a network device to maintain memory snapshots of computing devices, while limiting the amount of data that is transmitted by computing devices in order to maintain up to date or usable memory snapshot downloads by computing devices. Rather than periodically transmitting fresh memory snapshots or transmitting snapshot updates that include all of the data that has changed since the last full snapshot was transmitted, various embodiments identify selected sections or portions of memory to be monitored for changes, specify the types of changes justifying or requiring transmission of an incremental snapshot, and identify the type of information to be included in incremental snapshots. The type of information including the incremental snapshots may be less than the change data and/or analysis regarding the changed data.

In various embodiments, the information and criteria provided by the network device to the computing device specifying the types of memory data and information to be monitored as well as the amount and types of information regarding change data to be provided in an incremental snapshot may be less than the data that has changed in memory. Thus, unlike memory backup systems that provide all change data in incremental downloads, some embodiments may specify a subset of change data or information about the data that has changed sufficient to perform a memory forensic analysis. Downloading less than all of the change data may reduce the power demands on the computing device, as well as the bandwidth consumed in transmitting incremental snapshots.

The network device may be configured to identify the amount and types of information to be provided by computing devices in incremental snapshots by analyzing a stored memory snapshot for malware or particular issues, and identifying the types of data that will enable the network device to further diagnose, categorize, or otherwise identify malware or other issues involving the computing device. The information then communicated from the network device to the computing device identifying the criteria for recognizing changes in selected portions or sections of memory to be monitored may specify the fraction, subset, or characterization of the changes in data that should be transmitted in an incremental snapshot. Thus, the various embodiments enable incremental snapshots transmitted to the network device for analysis to include less than all of the data that has changed since an initial snapshot or the last incremental snapshot.

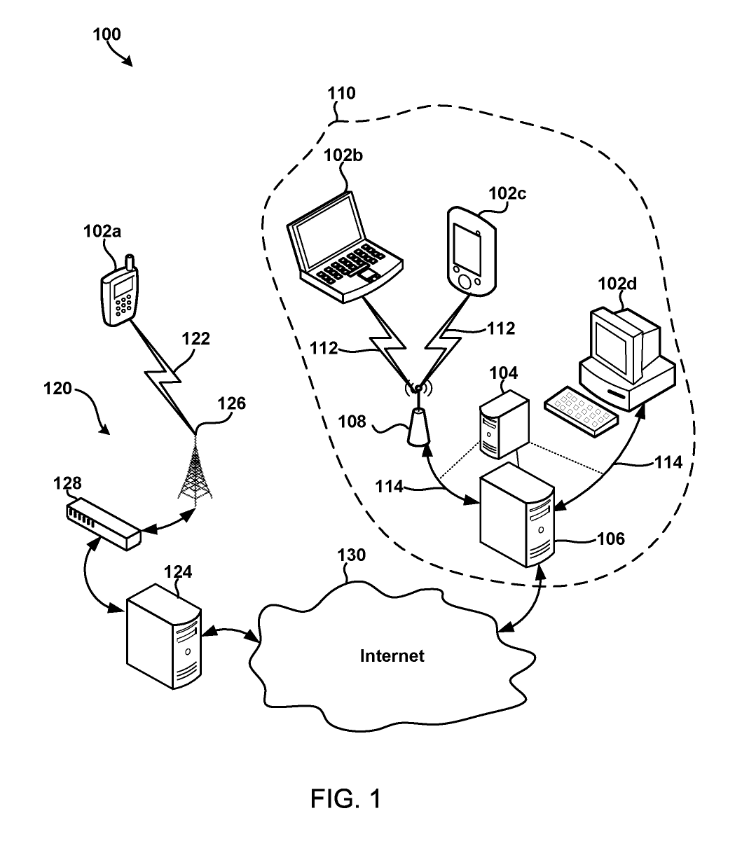

Various embodiments may enable computing devices 102a, 102b, 102c, 102d within a network 110 to be monitored for malware or other issues by a network device 104 as illustrated in FIG. 1. Such a network 110 may be wired (e.g., via wired communication links 114) and/or wireless (e.g., via wireless communication links 112 supported by one or more wireless access points 108). The network 110 may be facilitated by one or more routing servers 106. The network device 104 may be a separate processor or server (as illustrated) or may be implemented as software-enabled functionality within a server 106 supporting communications within the network. Additionally, the network device 104 may be located outside of a network 110, such as Lloyd in various servers forming “the cloud.”

The network device 104 may receive memory snapshots from various computing devices computing devices (e.g., 102b, 102c, 102d) within the network 110. The network device 104 may store received memory snapshots and perform a forensic analysis or other types of analysis on the stored data. The network device 104 may also communicate with the various computing devices (e.g., 102b, 102c, 102d) via the network 110 to provide each device with identified sections or portions of memory to be monitored along with criteria used for determining when an incremental snapshot should be obtained and the types of information to be included in incremental snapshots provided to the network device 104.

The network device 104 may also communicate with computing devices outside the network 110, such as mobile communication devices 102a, 102b, 102c, 102d. For example, the network device 104 may communicate with a remote computing device 102a connected to a cellular telephony network 120 with communications routed through the Internet 130. For example, a mobile telephony network 120 may include an Internet access server 124 that communicates with telephone routing equipment 128 that routes data messages to one or more base stations 126 that are in communication with the mobile computing device 102a via wireless communication links 122.

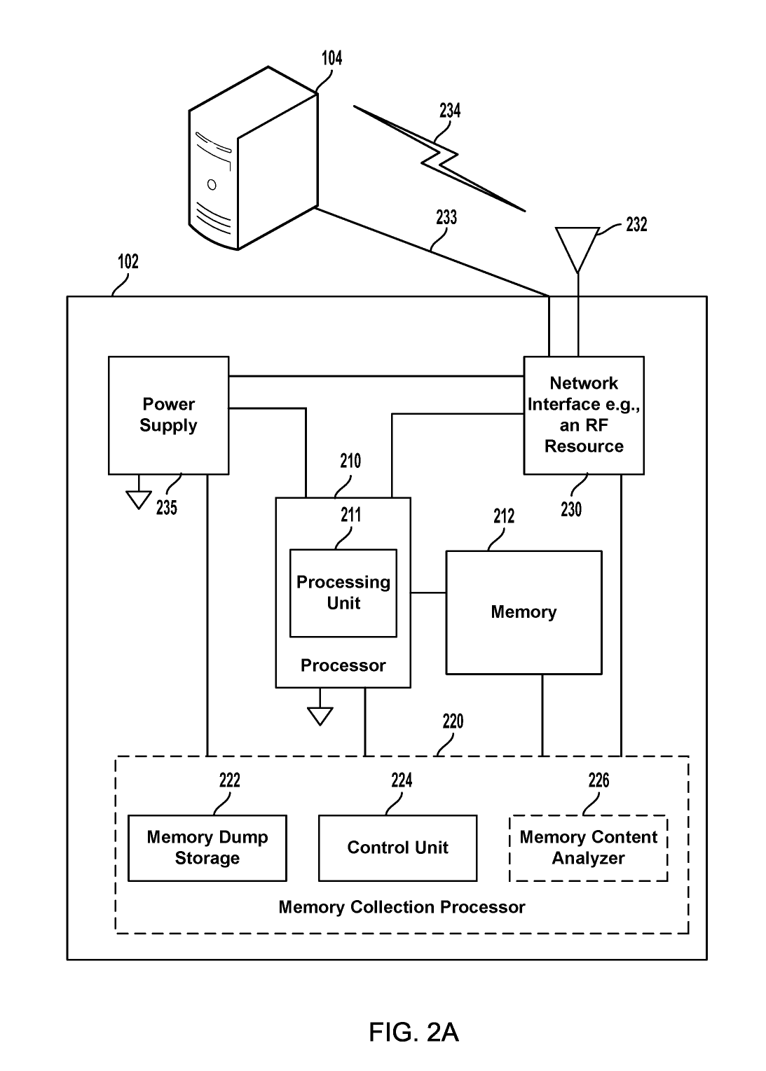

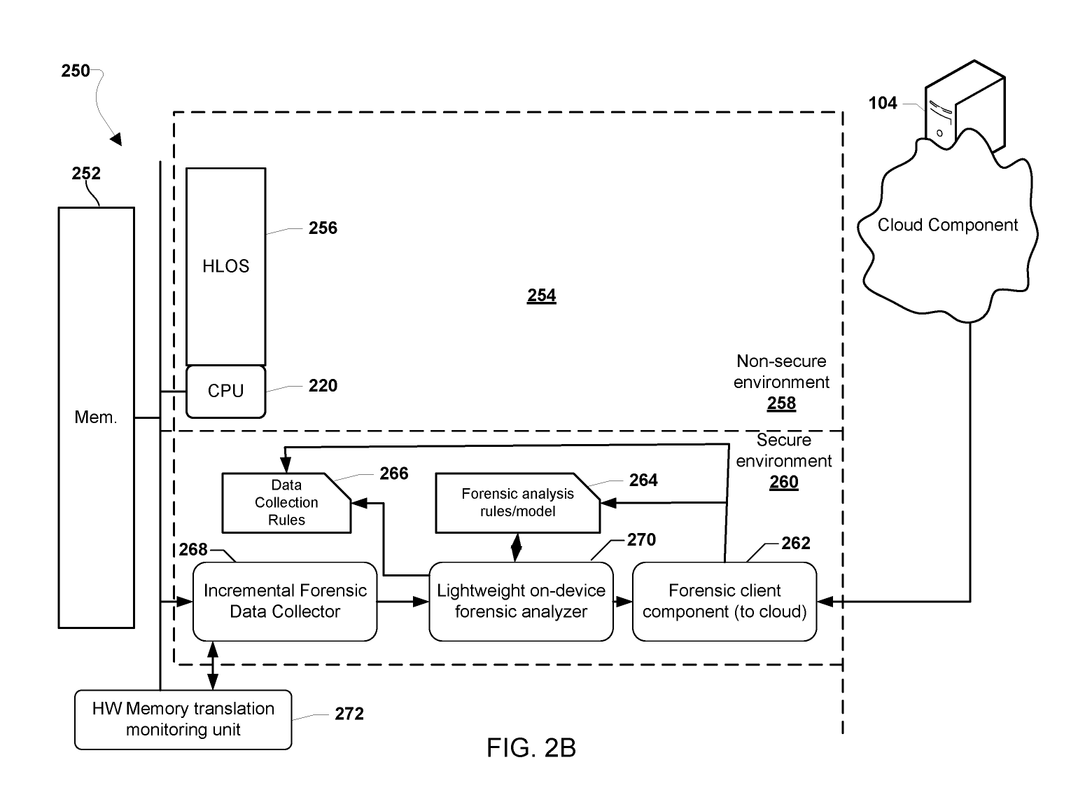

FIG. 2A is a schematic diagram illustrating components of a computing device 102 that may be configured to perform online memory data collection according to some embodiments. The computing device 102 may include various circuits and other electronic components used to power and control the operation of the computing device 102. The computing device 102 may include a processor 210, memory 212, and a network interface 230, which may be a wired network interface and/or radio frequency (RF) resource coupled to an antenna 232. The computing device 102 may further include a power supply 235. The network interface 230 may include various modems, memory stacks, data encoders, and transceivers configured to support the transmission and reception of data via wireless signals sent and received via an antenna 232.

The processor 210 may be configured with processor executable instructions to obtain and transmit memory snapshots to a network device 104 via the network interface 230, such as via a wired network connection 233 or a wireless communication link 234. The processor 210 may be further configured with processor executable instructions to monitor selected portions of memory according to information or criteria received from the network device 104. In some embodiments, the computing device 102 may include a memory data collection processor 220 configured to obtain and transmit memory snapshots to a network device 104, and optionally monitor selected portions of memory according to information or criteria received from the network device 104.

In some embodiments, the processor 210 may be dedicated hardware specifically adapted to perform various operations of the computing device 102, including, but not limited to, executing an operating system and/or various instances of one or more programs (i.e., processes). In some embodiments, the processor 210 may be or include a programmable processing unit 211 (e.g., a programmable microprocessor, microcomputer or multiple processor chip or chips) that may be programmed with processor-executable instructions to perform the various operations of the computing device 102. In some embodiments, the processor 210 may be a combination of dedicated hardware and a programmable processing unit 211.

In some embodiments, the memory 212 may store processor-executable instructions. The memory 212 may be any form of computer-readable memory, including one or more and combinations of volatile and non-volatile memory and internal and external memory devices.

In embodiments including a memory collection processor 220, the memory collection processor 220 may be dedicated hardware specifically adapted to perform online memory data collection for memory forensics in the computing device 102. In some embodiments, the memory data collection processor 220 may include a memory dump storage 222 and a programmable control unit 224 that may be programmed with processor-executable instructions to control performance of the online memory data collection from the memory 212 using the memory dump storage 222. In some embodiments, the memory data collection processor 210 may be a combination of dedicated hardware, the memory dump storage 222, and the programmable control unit 224. In some embodiments, the memory data collection processor 220 may be a programmable microprocessor, microcomputer or multiple processor chip or chips that can be configured by software instructions to perform online memory data collection from the memory 212 using the memory dump storage 222.

In some embodiments, the memory data collection processor 220 may optionally include a memory content analyzer 226 that monitors portions or sections of memory according to information, addresses and/or criteria specified by a network device 104 (e.g., a server).

In some embodiments, the processor 210 and the optional memory data collection processor 220 may be coupled to the network interface 230 in order to communicate with the network device 104. For example, the network interface 230 may be configured to receive and transmit signals 234 via a wired network connection 233 and/or an antenna 232, such as signals from/to a network device 104. Such a network device 104 may perform a memory forensics analysis on data collected by the memory data collection processor 220 and transmitted via the network interface 230. The network interface 230 may provide information received from a network device 104 to the processor 210 and/or the memory data collection processor 220, particularly information identifying portions or sections of memory to be monitored, criteria for recognizing changes in the identified portions/sections of memory warranting downloading an incremental snapshot, and/or information regarding the data to be included in incremental snapshots. The network interface 230 may operate in one or more of a number of radio frequency bands depending on the supported type of communications, such as via Bluetooth®, Wi-Fi® or a cellular telephone communication link. Alternatively or in addition, communications with the network device 104 may also be accomplished via a wired network connection.

The processor 210, the memory 212, the optional memory data collection processor 220, the network interface 230, and any other electronic components of the control device 100 may be powered by the power supply 235, which may be any form of power supply.

While the various components of the computing device 102 are illustrated in FIG. 2A as separate components, some or all of the components may be integrated together in a single device or module, such as a system-on-chip module.

FIG. 2B illustrates a computing device architecture including components and processing blocks according to some embodiments. In the example computing device 250 illustrated in FIG. 2B, the operations of monitoring memory sections or portions identified by the network device 104 as well as collecting data and generating an incremental snapshot are performed by a secure environment 260 of the computing device rather than in a separate memory collection processor (e.g., 220). Performing the functions of monitoring data collecting an incremental snapshot and transmitting the incremental snapshot to the network device 104 within a secure environment 260 of the processor may ensure that these functions are not compromised by malware unauthorized user manipulation of the computing device.

The computing device 250 may include memory 252 coupled to a processor 254 or central processing unit (CPU) and is configured with a high level operating system (HLOS) 256. The processor 254 and its operating system may be organized into a non-secure environment 258 in which most applications are executed, and a secure environment 260 that is limited to operations and functions that require a high level security to protect the computing device.

The functionality within the secure environment 260 may include a forensic client 262 that is configured to communicate via an available network (e.g., a telecommunication network supported by s network interface 230) with the network device 104. The forensic client 262 may be configured to receive information from the network device 100 for identifying selected sections or portions of memory 252 that are to be monitored as well as criteria or rules to be used in determining whether changes in data within the identified sections/portions of memory 252 require transmission of an incremental snapshot. The forensic client component 262 may provide such criteria or rules 266 to an incremental forensic data collector 268. The forensic client component 262 may also provide criteria, forensic analysis rules or analysis models 264 for generating an appropriate incremental snapshot to a lightweight on-device forensic analyzer 270.

The incremental forensic data collector 268 may utilize the criteria or rules 266 to determine the portions of the memory 252 to be monitored for changes. In some embodiments, the incremental forensic data collector 268 may identify to a hardware memory transaction monitoring unit 270 to the sections or portions of memory 252 to be monitored for changes. The hardware memory transaction monitoring unit 272 may then monitor the specified sections/portions of memory 252, such as by periodically sampling the data to determine whether changes, or monitoring right operations from the processor 210 to the memory 252 for write operations to the specified sections or portions.

When a change in the data within one or more specified sections or portions of the memory 252 is identified (e.g., by the hardware memory transaction monitoring unit 272), the incremental forensic data collector may sample all or a portion of the data that has changed in the memory 252. The incremental forensic data collector 268 may apply data collection rules 266 to the changed data to determine whether the changes warrant generating transmitting an incremental snapshot to the network device 104.

Not all changes to data within the identified sections of portions of the memory 252 may trigger the need for sending and incremental snapshot. Thus, the network device 104 may specify in data collection rules 266 the types of changes that trigger the need to update forensic analysis. If the incremental forensic data collector 268 determines that the changes they data received from the memory 252 do trigger the need to generate and transmit an incremental snapshot, the changed data may be passed to the lightweight on device forensic analyzer 270 for analysis according to the forensic analysis rules or models 264 received from the network device 104 via the forensic client component 262.

The lightweight on-device forensic analyzer 270 may use the forensic analysis rules or models 264 to determine the information that should be included within an incremental snapshot. In some cases, depending upon the forensic analysis performed on the original snapshot by the network device 104, only some of the changed data will need to be included in the incremental snapshot. In some cases, only the results of some defined analyses of the changed data may need to be provided in the incremental snapshot. In some cases, both an analysis of the changed data and at least some of the changed data that may be included in the incremental snapshot. Thus, the network device 104 is able to control the amount and types of information provided in incremental snapshot transmissions via forensic analysis rules or models 264 that are provided to the computing device 250.

The lightweight on-device forensic analyzer 270 may perform the defined analysis or data selections according to the forensic analysis rules or models 264 in order to generate an incremental snapshot. This may include formatting the information into an appropriate format (as may be defined by the network device 104) for transmission. The generated incremental snapshot may then be provided to the forensic client comport 262 for transmission to the network device 104 via an available communication link.

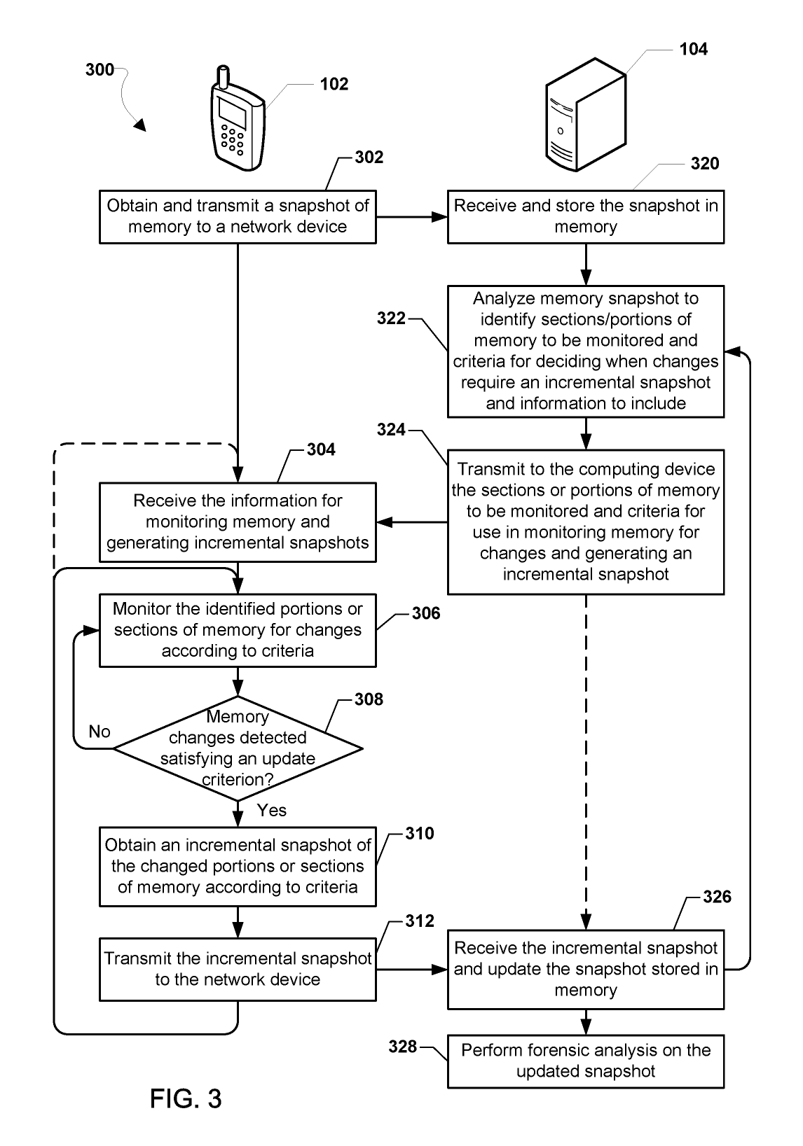

FIG. 3 illustrates a method 300 of performing online memory data collection according to some embodiments. With reference to FIGS. 1-3, operations of the method 300 may be performed by a memory data collection processor (e.g., 220) of a computing device 102 or in a secure environment 260 of a computing device (e.g., 250), such as by a frantic client complement 262, lightweight on-device frantic analyzer 270, an incremental forensic data collected 268, and/or a hardware memory transaction monitoring unit 272. For ease of reference, the processor or processes performing the operations within the computing device 102 are referred to generally herein as a “processor.”

In block 302, the processor of the computing device 102 may obtain a complete image of memory (e.g., 252) and transmit that image as a snapshot of memory to a network device 104.

In block 320, the network device may receive the memory snapshot from the computing device 102 and store the data in local memory in block 320.

In block 322, the network device may analyze the snapshot of the computing devices memory contents at least to identify selected portions or sections of memory that should be monitored by the computing device. This analysis may involve a form of forensic analysis.

As an example of operations that may be performed in block 322, the network device may perform forensic analysis on the stored snapshot of memory data and determine whether a complete diagnosis, categorization, or recognition of a malware or targeted issue can be determined. If evidence of an issue (e.g., malware, or other targeted issue) is insufficient to make a determination within a threshold level of probability or certainty, the forensic analysis results may be used to identify the additional types and memory locations of data that would enable the forensic analysis to reach a firm conclusion. This determination may then be used to identify criteria for the computing device to recognize that an incremental snapshot should be performed as well as specify a limited set or of information about changes in a selected portion or cried or section of memory that would enable a firm conclusion to be reached through the forensic analysis. This information may also be used to specify the type of information that should be provided by the computing device in incremental snapshots.

As another example of operations that may be performed in block 322, the network device may use of a classification model. In this example, the memory data snapshot may be analyzed to generate a vector of selected information based on the data present in the snapshot that characterizes critical aspects of the memory data. Such a data vector may then be applied to a classification model to determine whether a conclusion of malware, non-benign activity, or some other targeted issue can be determined. If the result of applying the behavior vector to the classification model results in an inconclusive result (e.g., a suspicion of an issue, or a probability of an issue falling below a determination threshold, etc.), the analysis may identify the elements within the data vector that would enable a firm conclusion to be reached. That result may then be used to identify for the computing device criteria for recognizing when and incremental snapshot update is required and the types of information that should be provided in such an incremental snapshot.

In block 324, the network device 104 may transmit to the computing device information identifying the sections or portions of memory to be monitored, as well as the criteria for use in monitoring changes in memory to determine whether an incremental snapshot is required (e.g., data collection rules 266). The information provided by the network device 104 in block 324 may also define the types of data and information to be included within an incremental snapshot as well as any formatting or rules for generating the incremental snapshot.

The types of information identified by the network device to be provided in incremental snapshots may be less than the data that has changed. For example, the data vector may not include the actual data, but information regarding data, such as an amount of data within a portion of memory, a frequency of change of data within a section of memory, a time since a last change in memory in the section of memory occurred, etc. Thus, the information provided by the network device to the computing device in block 324 regarding the types of information to be provided in an incremental snapshot may specify the information that will be used in a data vector to be applied to the characterizing model. In some embodiments, the computing device 102 may perform analyses on the recognized changed memory data according to instructions provided by the network device 104, and provide the requested information regarding the changes in memory at the monitored sections or portions in the incremental snapshot. Thus, instead of performing providing the changed data in an incremental snapshot, the computing device may provide metadata in the form of data regarding the changed data.

In block 304, the computing device 102 may receive the information for monitoring memory and for generating incremental snapshots from the network device 104. For example, if forensic client 262 may receive the information from the network device 104, and pass the data collection rules to 66 to an incremental forensic data collected 268 and forensic analysis rules and models to 64 to a lightweight on device forensic analyzer 270.

In block 306, the processor of the computing device 102 may monitor the identify portions or sections of memory for changes according to the criteria or rules (e.g., 266) received from the network device 104. For example, an incremental forensic data collected 268 may work with a hardware memory transaction monitoring unit 272 to monitor the identified sections of portions of memory for changes.

In determination block 308, the processor may determine whether any changes within the identified sections or portions of memory satisfy criteria or rules (e.g., 266) for generating an incremental snapshot. For example, the incremental forensic data collector 268 may analyze the changes in data obtained from the memory 252 according to data collection rules 266 to determine whether an incremental snapshot should be generated.

In response to determining that changes in memory within the identified sections of portions do not satisfy a ruler criterion for generating an incremental snapshot (i.e., determination block 308=“No”), the processor may continue to monitor the identified portions or sections of memory for changes in block 306.

In response to determining that changes in memory within the identified sections of portions satisfy a ruler criterion for generating an incremental snapshot (i.e., determination block 308=“Yes”), the processor may obtain an incremental snapshot of the change portions or sections of memory according to criteria defined by the network device 104 in block 310. For example, changed memory data collected by an incremental forensic data collector 268 may be analyzed by a lightweight on-device forensic analyzer 270 according to forensic analysis rules and models 264 to generate the information to include in the incremental snapshot. Information may include some or all of the changed the data and/or an analysis of the changed data according to rules or criteria provided by the network device 104. The operations in block 310 may also include formatting the incremental snapshot for transmission to the network device 104.

In block 312, the computing device 102 may transmit the incremental snapshot to the network device 104 via an available communication link. The processor may then continue to monitor the identified portions or sections of memory for changes according to the data collection rules in block 306. Sometime later, the computing device 102 may receive from the network device 104 new information for monitoring memory and generating incremental snapshot in block 304.

In block 326, the network device 104 may receive the incremental snapshot from the computing device 102, and use the received information to update the snapshot stored in memory. For example, the network device 104 may use information regarding the changed data (versus there is data itself) to update the memory snapshot stored in the network device. In some embodiments, the network device 104 may then analyze the updated snapshot to identify sections of portions of memory to be monitored and criteria for use in monitoring the memory for changes, as well as information to be included in incremental snapshots in block 322 as described.

In block 328, the network device 104 may perform forensic analysis on the updated memory snapshot. Any of a variety of forensic analyses may be performed. As an example, the network device a scan the memory snapshot for patterns of data or instructions matching known patterns of malware or other targeted issues. As another example, the forensic analysis may focus on selected portions of the memory snapshot, such as portions storing protocol stacks, instruction cues, application instructions, etc. looking for patterns of known malware or other targeted issues or data inconsistent with normal operations. As a further example, analyses may be performed on selected portions of data within the memory snapshot to generate the sticks or characterize the data, with the results used to populate a data vector that can then be analyzed by a classification model according to known methods.

In some embodiments, the forensic analysis performed in block 328 may be the same analysis as performed in block 322. For example, in some embodiments, an additional output of the analysis performed in block 322 may be conclusions from the forensic analysis, and no separate analysis may be performed (i.e., block 328 may not be performed).

The operations in the method 300 may be performed continuously to enable near continuous forensic analysis or monitoring of memory contents within computing devices. Periodically, the method 300 may be repeated from block 302 when computing devices obtain a new complete snapshot of memory and transmit network device 104.

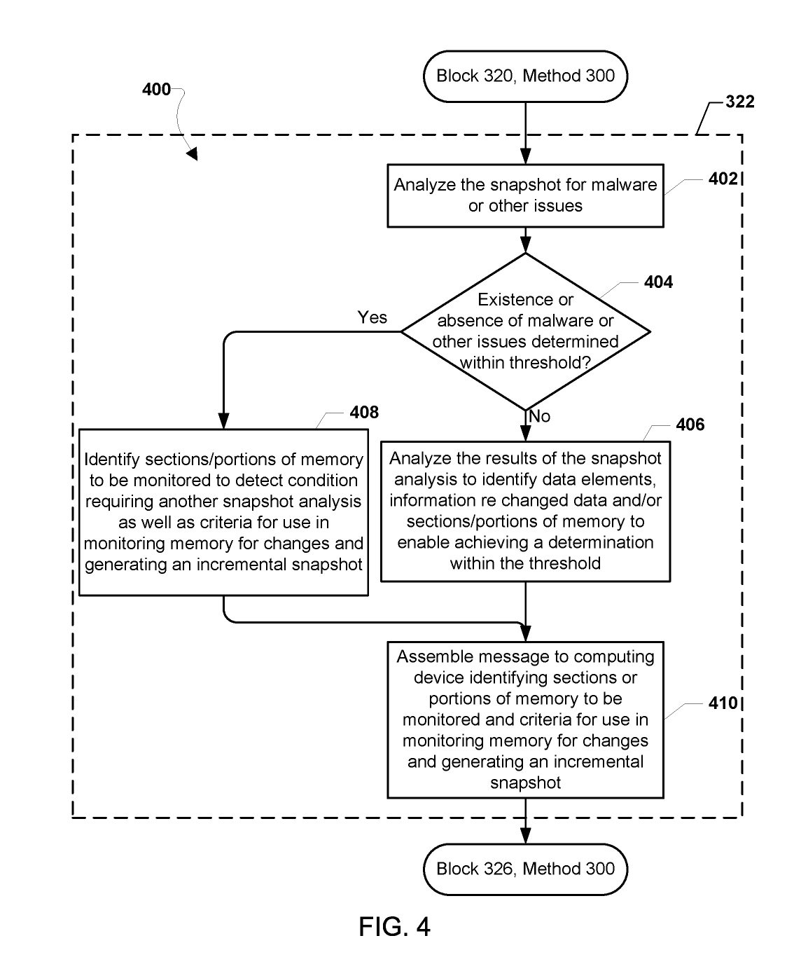

FIG. 4 illustrates an example method 400 that may be implemented in a network device for determining sections or portions of memory to be monitored, as well as criteria for determining whether an interim snapshot of memory should be obtained and the types of information to be included in an incremental snapshot by a computing device according to some embodiments. With reference to FIGS. 1-4, the method 400 is an example of operations that may be performed by a network device as part of the operations in block 322 of the method 300. The operations of the method 400 may be performed by a network device processor, or by a server within the network executing the functionality of a network device in software.

In block 402, the network device processor may analyze the stored memory snapshot of the computing device using a variety of analysis methods. As described, the server may perform forensic analysis on the memory snapshot using forensic analysis methods for which the memory snapshots are being obtained. In some embodiments, the analysis performed on the memory snapshot in block 402 may be a different form of analysis, such as applying a classification model to a data vector made up of data selected from the memory snapshot or the results of analysis of the data within the memory snapshot.

In block 404, the processor may determine whether a conclusion regarding the memory snapshot can be achieved within a threshold level of certainty by the analysis performed in block 402. For example, the processor may determine whether forensic analysis results in a conclusion regarding non-benign behavior or a targeted issue within a predefined threshold of certainty or probability. Forensic analysis will typically involve a number of tests on the data, and reaching a firm conclusion may require a certain percentage of the tests to result in a positive or negative answer. If an insufficient number of tests are satisfied, this may indicate that a firm conclusion cannot be reached with the current memory data snapshot. Similarly, in embodiments in which the analysis in block 402 involves applying data vector based on the snapshot to a classification model the result may be an indication or suggestion that a non-benign or other targeted issue is possible but not established within a predefine threshold for reaching a conclusion.

In determination block 404, the network device may determine whether an existence or absence of malware or other issue can be determined by the analysis conducted block 402 within some threshold level of certainty or probability.

In response to determining that the existence or absence of malware or other issue can be determined within the threshold level of certainty or probability (i.e., determination block 404=“Yes”), the network device may identify sections or portions of memory to be monitored by the computing device in order to detect a condition requiring another snapshot analysis, as well as criteria for use in monitoring memory for changes and generating an incremental snapshot in block 408. For example, the network device may identify portions of the memory where certain changes in data would indicate or suggest that the conclusion (e.g., of benign or non-benign processes) reached in block 402 may no longer be valid. For example, if the analysis in block 402 concluded that all activities were non-benign or a targeted issue is not present in the computing device, the network device may identify selected sections or portions of memory where changes in the data could be a sign of non-benign behavior or the existence of the targeted issue.

In response to determining that the existence or absence of malware or other issue cannot be determined within the threshold level of certainty or probability (i.e., determination block 404=“No”), the network device may identify in block 406, the sections or portions of memory to be monitored and criteria or rules for changes in data within those sections/portions that could provide additional information sufficient to reach a conclusion in the forensic analyses performed in block 402. For example, if the analysis performed in block 402 indicates the possibility of malware or targeted issue but some of the data within the memory snapshot is inconsistent with such a conclusion, the network device may identify the corresponding sections of portions of memory to monitor and rules for recognizing when data changes would be sufficient to further support that conclusion.

In block 410, the network device 104 may assemble a message to the computing device identifying sections of portions of memory to be monitored, along with the criteria for use in monitoring memory for changes requiring an incremental snapshot, and criteria or rules for generating such an incremental snapshot. This message may then be transmitted by the network device 104 in block 326 in the method 300.

Various embodiments improve the operations of computing devices working with network devices for supporting forensic analysis of memory by reducing the amount of memory snapshots communicated over the network to specific types of information needed by the network device for performing the forensic analysis. Thus, the various embodiments reduce the power consumed by computing devices supporting network forensic methods as well as reducing the bandwidth consumed by memory snapshot transmissions.

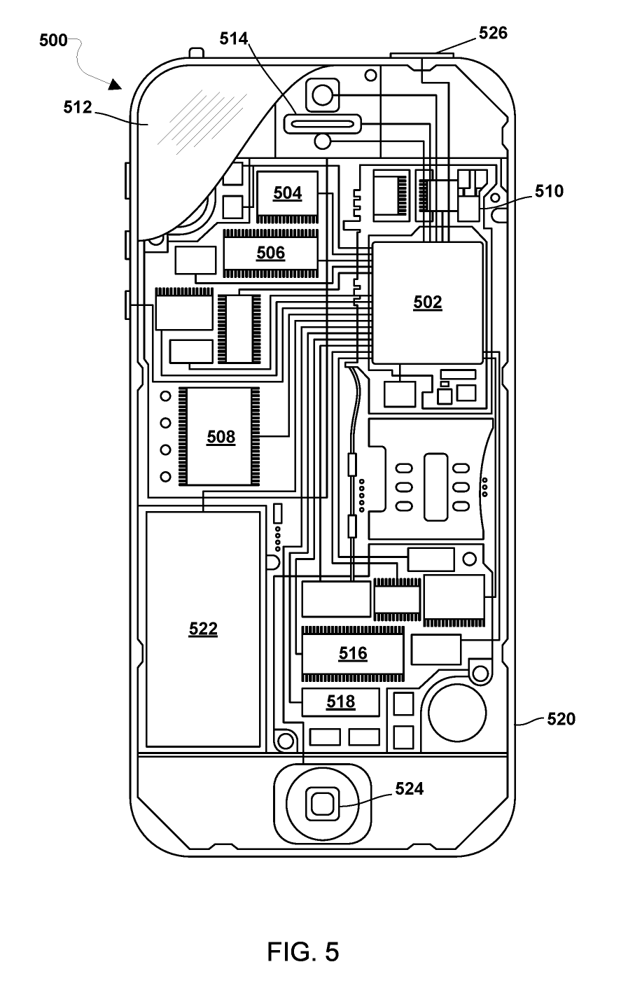

The various embodiments may be implemented on any of a variety of commercially available computing devices. For example, FIG. 5 is a schematic diagram illustrating components of a smartphone type mobile communication device 500 that may be configured to implement methods according to some embodiments, including the embodiments of the methods 300 and 500 described with reference to FIGS. 3 and 4.

A mobile communication device 500 may include a processor 502 coupled to a touchscreen controller 504 and an internal memory 506. The processor 502 may be one or more multi-core integrated circuits designated for general or specific processing tasks. The internal memory 506 may be volatile or non-volatile memory. The internal memory 506 may store processor-executable instructions configured to cause the mobile computing device 500 to perform operations of various embodiment methods. The internal memory 506 may also store application and other data, including data transmitted to a server as a memory snapshot and/or an incremental snapshot of memory.

The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the communication device 500 need not have touch screen capability. Additionally, the mobile communication device 500 may include a cellular network transceiver 508 coupled to the processor 502 and to an antenna 510 for sending and receiving electromagnetic radiation that may be connected to a wireless data link. The transceiver 508 and the antenna 510 may be used with the above-mentioned circuitry to implement various embodiment methods.

The mobile communication device 500 may have a cellular network transceiver 508 coupled to the processor 502 and to an antenna 510 and configured for sending and receiving cellular communications. The mobile communication device 500 may include one or more subscriber identity module (SIM) cards 516, 518 coupled to the transceiver 508 and/or the processor 502 and may be configured as described above.

The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to the peripheral device connection port to receive a charging current from a source external to the communication device 500. The communication device 500 may also include a physical button 524 for receiving user inputs. The mobile communication device 500 may also include a power button 526 for turning the mobile communication device 500 on and off.

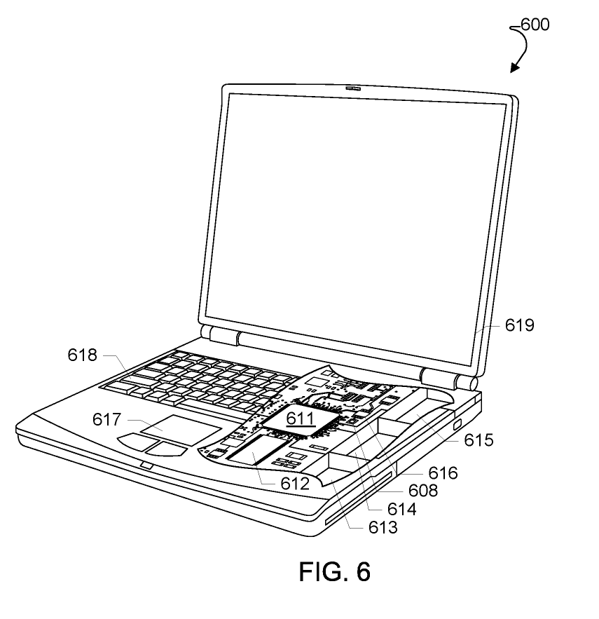

The various embodiments (including, but not limited to, embodiments described above with reference to FIGS. 1-4) may be implemented in a wide variety of computing systems include a computer 600 an example of which in the form of a laptop computer is illustrated in FIG. 6. Many computers include a touchpad touch surface 617 that serves as the computer's pointing device, and thus may receive drag, scroll, and flick gestures similar to those implemented on computing devices equipped with a touch screen display and described above. A computer 600 will typically include a processor 611 coupled to volatile memory 612 and a large capacity nonvolatile memory, such as a disk drive 613 or Flash memory. The memory 612, 613 may store processor-executable instructions configured to cause the personal computer 500 to perform operations of various embodiment methods. The memory 612, 613 may also store application and other data, including data transmitted to a server as a memory snapshot and/or an incremental snapshot of memory

Additionally, the computer 600 may have one or more antenna 608 for sending and receiving electromagnetic radiation that may be connected to a wireless data link and/or cellular telephone transceiver 616 coupled to the processor 611. The computer 600 may also include a floppy disc drive 614 and a compact disc (CD) or drive 615 coupled to the processor 611. In a notebook configuration, the computer housing includes the touchpad 617, the keyboard 618, and the display 619 all coupled to the processor 611. Other configurations of the computing device may include a computer mouse or trackball coupled to the processor (e.g., via a Universal Serial Bus (USB) input) as are well known, which may also be used in conjunction with the various embodiments. In various embodiments (including, but not limited to, embodiments described above with reference to FIGS. 1-5) the wide variety of computing systems may include a desktop computer or workstation (not shown) including any combination and configuration of the components of the computer 600.

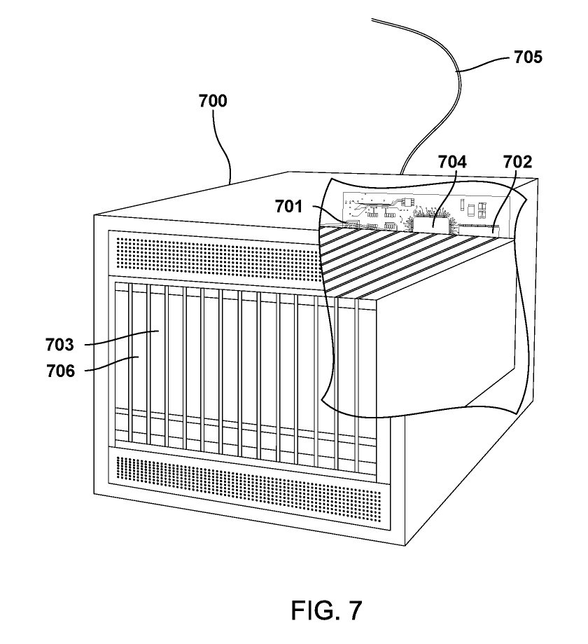

FIG. 7 is a schematic diagram illustrating components of an example of a network device in the form of a server 700 that may be configured to implement methods according to some embodiments, including the embodiments of the methods 300 and 400 described with reference to FIGS. 3 and 4. Such a server 700 typically includes a processor 701 coupled to volatile memory 702 and a large capacity nonvolatile memory, such as a disk drive 703. The server 700 may also include a removable large capacity nonvolatile memory 706 (e.g., floppy disc drive, CD drive, or digital video disc (DVD) drive) coupled to the processor 701. The server 700 may also include network access ports 704 coupled to the processor 701 for establishing data connections with a network 705, such as a local area network coupled to other broadcast system computers and servers.

The processor 701 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 702, 703 before they are accessed and loaded into the processor 701. The processor 701 may include internal memory sufficient to store the application software instructions.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, two or more microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium.

Non-transitory computer-readable or processor-readable storage media may be any form of storage media that may be accessed by a computer or a processor and used to store program code in the form of instructions or data structures executable by a processor (e.g., random access memory (RAM), read-only memory (ROM), electronic erasable and programmable ROM (EEPROM), FLASH memory, compact disc (CD)-ROM or other optical disk storage, magnetic disk storage or other magnetic storage smart objects). Combinations of different types of memory devices are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of performing memory data collection for memory forensics in a computing device, comprising:
receiving, in the computing device from a network device, information identifying a section or portion of memory to be monitored for changes from a memory snapshot previously provided by the computing device to the network device;
monitoring, by a processor of the computing device, the identified section or portion of memory for changes in data; and
determining, by the processor, whether data changes in the monitored section or portion of memory satisfy a criterion for transmitting an incremental snapshot of memory if data within a monitored section or portion of memory has changed, wherein the criterion for transmitting an incremental snapshot of memory is defined in the information received from the network device.

2. The method of claim 1, further comprising:
transmitting an incremental snapshot of memory from the computing device to the network device in response to determining that data changes in the monitored section or portion of memory satisfy the criterion for transmitting the incremental snapshot of memory.

3. The method of claim 2, further comprising generating the incremental snapshot of memory according to instructions received from the network device in the information received from a network device.

4. The method of claim 3, wherein generating the incremental snapshot of memory comprises:
performing an analysis on data that changed in the identified section or portion of memory according to the instructions received from the network device; and
including results of the analysis within the incremental snapshot of memory.

5. The method of claim 3, wherein generating the incremental snapshot of memory comprises performing an analysis on data that changed in the identified the section or portion of memory according to the instructions received from the network device, wherein results of the analysis are the incremental snapshot of memory.

6. The method of claim 3, wherein operations of monitoring identified sections of portion of memory, determining whether data changes in the monitored section or portion of memory satisfy the criterion for transmitting an incremental snapshot of memory, and generating the incremental snapshot of memory are performed in a secure environment within the computing device.

7. The method of claim 3, wherein operations of monitoring identified sections of portion of memory, determining whether data changes in the monitored section or portion of memory satisfy the criterion for transmitting an incremental snapshot of memory, and generating the incremental snapshot of memory are performed in a memory collection processor within the computing device.

8. The method of claim 1, wherein determining whether data changes in the monitored section or portion of memory satisfy the criterion for transmitting the incremental snapshot of memory comprises:
applying data collection rules received from the network device to changed data within the monitored section or portion of memory to determine whether changed data should be processed to generate an incremental snapshot of memory.

9. A computing device, comprising:
a memory;
a network interface configured to communicate data via a network; and
a processor coupled to the memory and the network interface, and configured to perform operations comprising:
receiving from a network device information identifying a section or portion of the memory to be monitored for changes from a memory snapshot previously provided by the computing device to the network device;
monitoring the identified section or portion of the memory for changes in data; and
determining whether data changes in a monitored section or portion of the memory satisfy a criterion for transmitting an incremental snapshot of memory if data within the monitored section or portion of memory has changed, wherein the criterion for transmitting an incremental snapshot of memory is defined in the information received from the network device.

10. The computing device of claim 9, wherein the processor is configured to perform operations further comprising:
transmitting an incremental snapshot of the memory to the network device in response to determining that data changes in the monitored section or portion of memory satisfy the criterion for transmitting the incremental snapshot of memory.

11. The computing device of claim 10, wherein the processor is configured to perform operations further comprising generating the incremental snapshot of the memory according to instructions received from the network device in the information received from a network device.

12. The computing device of claim 11, wherein the processor is configured to perform operations such that generating the incremental snapshot of memory comprises:
performing an analysis on data that changed in the identified section or portion of memory according to the instructions received from the network device; and
including results of the analysis within the incremental snapshot of memory.

13. The computing device of claim 11, wherein the processor is configured to perform operations such that generating the incremental snapshot of memory comprises performing an analysis on data that changed in the identified the section or portion of memory according to the instructions received from the network device, wherein results of the analysis are the incremental snapshot of memory.

14. The computing device of claim 11, wherein the processor is further configured with a secure environment and configured with processor-executable instructions to perform operations of monitoring identified sections of portion of memory, determining whether data changes in the monitored section or portion of memory satisfy the criterion for transmitting an incremental snapshot of memory, and generating the incremental snapshot of memory in the secure environment.

15. The computing device of claim 11, further comprising a memory collection processor, and configured with processor-executable instructions to perform operations of monitoring identified sections of portion of memory, determining whether data changes in the monitored section or portion of memory satisfy the criterion for transmitting an incremental snapshot of memory, and generating the incremental snapshot of memory in the memory collection processor.

16. The computing device of claim 10, wherein the processor is configured to perform operations such that determining whether data changes in the monitored section or portion of memory satisfy the criterion for transmitting the incremental snapshot of memory comprises:
applying data collection rules received from the network device to changed data within the monitored section or portion of memory to determine whether changed data should be processed to generate an incremental snapshot of memory.

17. A computing device, comprising:
means for receiving from a network device information identifying a section or portion of memory to be monitored for changes from a memory snapshot previously provided by the computing device to the network device;
means for monitoring the identified section or portion of memory for changes in data;
means for determining whether data changes in the monitored section or portion of memory satisfy a criterion for transmitting an incremental snapshot of memory if data within the monitored section or portion of memory has changed, wherein the criterion for transmitting an incremental snapshot of memory is defined in the information received from the network device; and
means for transmitting an incremental snapshot of memory to the network device in response to determining that data changes in the monitored section or portion of memory satisfy the criterion for transmitting the incremental snapshot of memory.

18. The computing device of claim 17, further comprising means for generating the incremental snapshot of memory according to instructions received from the network device in the information received from a network device.

19. The computing device of claim 18, wherein means for generating the incremental snapshot of memory comprises:
means for performing an analysis on data that changed in the identified section or portion of memory according to the instructions received from the network device; and
means for including results of the analysis within the incremental snapshot of memory.

20. The computing device of claim 18, wherein means for generating the incremental snapshot of memory comprises means for performing an analysis on data that changed in the identified the section or portion of memory according to the instructions received from the network device, wherein results of the analysis are the incremental snapshot of memory.

21. The computing device of claim 18, wherein:
means for monitoring identified sections of portion of memory comprises means for monitoring identified sections of portion of memory in a secure environment;
means for determining whether data changes in the monitored section or portion of memory satisfy the criterion for transmitting an incremental snapshot of memory comprises means for determining whether data changes in the monitored section or portion of memory satisfy the criterion for transmitting an incremental snapshot of memory in the secure environment; and
means for generating the incremental snapshot of memory comprises means for generating the incremental snapshot of memory in the secure environment.

22. The computing device of claim 18, further comprising means for determining whether data within the monitored section or portion of memory has changed in the secure environment, wherein:
means for monitoring identified sections of portion of memory and means for determining whether data within the monitored section or portion of memory has changed comprise a memory collection processor;
means for determining whether data changes in the monitored section or portion of memory satisfy the criterion for transmitting an incremental snapshot of memory comprises means for determining whether data changes in the monitored section or portion of memory satisfy the criterion for transmitting an incremental snapshot of memory in the memory collection processor; and
means for generating the incremental snapshot of memory comprises means for generating the incremental snapshot of memory in the memory collection processor.

23. The computing device of claim 17, wherein means for determining whether data changes in the monitored section or portion of memory satisfy the criterion for transmitting the incremental snapshot of memory comprises:
means for applying data collection rules received from the network device to changed data within the monitored section or portion of memory to determine whether changed data should be processed to generate an incremental snapshot of memory.

24. A non-transitory processor-readable storage medium having stored thereon processor-executable instructions configured to cause a processor of a computing device to perform operations comprising:
receiving from a network device information identifying a section or portion of memory to be monitored for changes from a memory snapshot previously provided by the computing device to the network device;
monitoring the identified section or portion of memory for changes in data;
determining whether data changes in the monitored section or portion of memory satisfy a criterion for transmitting an incremental snapshot of memory if within the monitored section or portion of memory has changed, wherein the criterion for transmitting an incremental snapshot of memory is defined in the information received from the network device; and
transmitting an incremental snapshot of memory to the network device in response to determining that data changes in the monitored section or portion of memory satisfy the criterion for transmitting the incremental snapshot of memory.

25. The non-transitory processor-readable storage medium of claim 24, wherein the stored processor-executable are configured to cause a processor of a computing device to perform operations further comprising generating the incremental snapshot of memory according to instructions received from the network device in the information received from a network device.

26. The non-transitory processor-readable storage medium of claim 25, wherein the stored processor-executable are configured to cause a processor of a computing device to perform operations such that generating the incremental snapshot of memory comprises:
performing an analysis on data that changed in the identified section or portion of memory according to the instructions received from the network device; and
including results of the analysis within the incremental snapshot of memory.

27. The non-transitory processor-readable storage medium of claim 25, wherein the stored processor-executable are configured to cause a processor of a computing device to perform operations such that generating the incremental snapshot of memory comprises performing an analysis on data that changed in the identified the section or portion of memory according to the instructions received from the network device, wherein results of the analysis are the incremental snapshot of memory.

28. The non-transitory processor-readable storage medium of claim 25, wherein the stored processor-executable are configured to cause a processor of a computing device to perform operations such that operations of monitoring identified sections of portion of memory, determining whether data changes in the monitored section or portion of memory satisfy the criterion for transmitting an incremental snapshot of memory, and generating the incremental snapshot of memory are performed in a secure environment within the computing device.

29. The non-transitory processor-readable storage medium of claim 25, wherein the stored processor-executable are configured to cause a processor of a computing device to perform operations such that operations of monitoring identified sections of portion of memory, determining whether data changes in the monitored section or portion of memory satisfy the criterion for transmitting an incremental snapshot of memory, and generating the incremental snapshot of memory are performed in a memory collection processor within the computing device.

30. The non-transitory processor-readable storage medium of claim 24, wherein the stored processor-executable are configured to cause a processor of a computing device to perform operations such that determining whether data changes in the monitored section or portion of memory satisfy the criterion for transmitting the incremental snapshot of memory comprises:
applying data collection rules received from the network device to changed data within the monitored section or portion of memory to determine whether changed data should be processed to generate an incremental snapshot of memory.
